(19) United States
(12) Patent Application Publication
(10) Pub. No.: US 2023/0415532 A1
(43) Pub. Date: Dec. 28, 2023

(54) SYSTEM AND METHOD FOR VEHICLE DATA COMMUNICATION

(71) Applicant: R.A. Phillips Industries, Inc., Santa Fe Springs, CA (US)

(72) Inventor: Raymond A. Suda, Sterling Heights, MI (US)

(21) Appl. No.: 18/341,740

(22) Filed: Jun. 26, 2023

Related U.S. Application Data
(60) Provisional application No. 63/355,409, filed on Jun. 24, 2022.

(51) Int. Cl. B60D 1/64; H04B 3/54; H04L 9/08

(52) U.S. Cl. CPC B60D 1/64; H04B 3/54; H04L 9/0869

(57) ABSTRACT

A vehicle communication system includes an electrical connector coupled to a first vehicle and including a plurality of pins configured to carry signals between the first vehicle and a second vehicle, the plurality of pins including a first pin configured to receive electrical power and a second pin configured to act as a signal ground, and a communication circuit coupled to the first and second pins of the electrical connector and configured to transmit an identification signal on the first pin to the second vehicle.

### CROSS-REFERENCE TO RELATED APPLICATION(S)

This application claims priority to, and the benefit of, U.S. Provisional Application No. 63/355,409 (“VEHICLE DATA COMMUNICATION APPARATUS AND METHOD”), filed on Jun. 24, 2022, the entire content of which is incorporated herein by reference.

### FIELD

Aspects of the present disclosure relate to vehicle communication systems and methods of using the same.

### BACKGROUND

The standardized connections in heavy duty vehicles, such as tractors and trailers, allow for interchangeability among different users. Components like trailers can be detached from one tractor and connected to another, leading to multiple operators and users throughout their lifespan. Tracking methods have been developed to monitor these components, but they are often cumbersome and limited in effectiveness. The current practice involves manually recording identification numbers painted or applied to the components, which is time-consuming and prone to errors. Bar-code and magnetic-stripe identification systems may be used to reduce human error but have limitations, including vulnerability to environmental conditions and the need for close proximity for reading.

It would be desirable to provide improvements in tractor-trailer communication and identification systems.

The above information disclosed in this Background section is only for enhancement of understanding of the background of the invention and therefore it may contain information that does not form the prior art that is already known to a person of ordinary skill in the art.

### SUMMARY

Aspects of embodiments of the present disclosure are directed to improved vehicle identification systems and methods for identifying tractor/trailer rigs. In some embodiments, the communication system includes an electrical connector (e.g., a J560 socket or plug) with a plurality of conductive pins that is capable of mating with a corresponding connector and connecting the electrical systems of the tractor and trailer. The connector has an integrated communication circuit that is electrically coupled to at least two of the pins of the socket to receive electrical power and to transmit the vehicle identification information of one of the tow and towed vehicles to the other. The communication circuit is configured to transmit the identification signal at every power cycle, when the power brake light signal is activated, or at pre-determined intervals while powered.

According to some embodiments of the present disclosure, there is provided a vehicle communication system including: an electrical connector coupled to a first vehicle and including a plurality of pins configured to carry signals between the first vehicle and a second vehicle, the plurality of pins including a first pin configured to receive electrical power and a second pin configured to act as a signal ground; and a communication circuit coupled to the first and second pins of the electrical connector and configured to transmit an identification signal on the first pin to the second vehicle.

In some embodiments, the communication circuit is within a housing of, and integrated within, the electrical connector.

In some embodiments, the identification signal is configured to identify the first vehicle to the second vehicle.

In some embodiments, the first vehicle is tow vehicle and the second vehicle is a towed vehicle.

In some embodiments, the first vehicle is towed vehicle and the second vehicle is a tow vehicle.

In some embodiments, the communication circuit is configured to transmit the identification signal via a power line communication (PLC) protocol.

In some embodiments, the plurality of pins further includes a third pin configured to receive a brake light power signal from the second vehicle, and the communication circuit is further coupled to the third pin and is configured to monitor presence of the brake light power signal at the third pin.

In some embodiments, the communication circuit is further configured to transmit the identification signal in response to presence of the brake light power signal.

In some embodiments, the communication circuit is configured to be electrically powered through the first and second pins.

In some embodiments, the communication circuit includes an internal battery configured to power the communication circuit in the absence of power on the first pin.

In some embodiments, the communication circuit is configured to detect application of power to the first pin and to transmit the identification signal in response to detecting the application of power.

In some embodiments, the electrical connector is a 7-pin J560 socket or a 7-pin J560 plug.

In some embodiments, the identification signal is based on an identifier associated with a vehicle identification number (VIN) of the first vehicle and an encryption key, and includes a code indicating whether the identifier is encrypted.

In some embodiments, the identifier includes the VIN of the first vehicle or a unique value identifying the vehicle communication system, the unique value being mapped to the VIN of the first vehicle.

In some embodiments, the encryption key is based on a manufacturing date of the first vehicle, and the code includes a binary bit.

In some embodiments, the communication circuit is configured to generate the identification signal by encrypting an identifier associated with a vehicle identification number (VIN) of the first vehicle via an encryption key.

In some embodiments, the communication circuit is configured to generate the identification signal by: generating a random seed number; intertwining bits of the random seed number and an identifier associated with a vehicle identification number (VIN) of the first vehicle to generate an intertwined value; encrypting the intertwined value via an encryption key to generate an encrypted identifier; and scrambling bits of the encrypted identifier to generate the identification signal.

According to some embodiments of the present disclosure, there is provided a method of transmitting an identification signal by a vehicle communication system, the method including: identifying an identifier associated with a vehicle identification number (VIN) of a first vehicle coupled to the vehicle communication system; generating a random seed number; intertwining bits of the random seed number and the identifier to generate an intertwined value; encrypting the intertwined value via an encryption key to generate an encrypted identifier; scrambling bits of the encrypted identifier to generate the identification signal; and transmitting the identification signal to a second vehicle coupled to the first vehicle.

In some embodiments, the identifier includes the VIN of the first vehicle or a unique value identifying the vehicle communication system, the unique value being mapped to the VIN of the first vehicle.

According to some embodiments of the present disclosure, there is provided a method of vehicle identification, the method including: identifying an identifier associated with a vehicle identification number (VIN) of a first vehicle; coding the identifier to generate an identification signal; transmitting the identification signal to a second vehicle that is electrically coupled to the first vehicle; transmitting a transmission signal corresponding to the identification signal to a remote server; and receiving, from the remote server, the VIN of the first vehicle at the second vehicle.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure but are intended to be illustrative only.

FIG. 1 illustrates a vehicle utilizing the vehicle communication system, according to some embodiments of the present disclosure.

FIG. 2 illustrates a perspective view of an electrical connector of the vehicle communication system, according to some embodiments of the present disclosure.

FIG. 3A illustrates a front exploded view of the electrical connector of the vehicle communication system, embodied as a socket, according to some embodiments of the present disclosure.

FIG. 3B illustrates a rear exploded view of the electrical connector 140 of FIG. 3A, according to some embodiments of the present disclosure.

FIG. 3C illustrates a perspective view of the connector of the vehicle communication system, embodied as a plug, according to some embodiments of the present disclosure.

FIG. 3D illustrates a partial internal view of the electrical plug connector, showing the communication circuit in relation to the plug pins, according to some embodiments of the present disclosure.

FIG. 3E illustrates a side view of an internal chamber of the plug connector, according to some embodiments of the present disclosure.

FIG. 4 illustrates a block diagram of the vehicle communication system and its interconnection with the electrical system of a tow vehicle, according to some embodiments of the present disclosure.

FIG. 5 is a flow diagram illustrating the process of transmitting an identification signal by the vehicle communication system, according to some embodiments of the present disclosure.

FIG. 6 is a flow diagram illustrating the process of vehicle identification by the a vehicle identification system, according to some embodiments of the present disclosure.

### DETAILED DESCRIPTION

The detailed description set forth below in connection with the appended drawings is intended as a description of illustrative embodiments of a trailer system including a tandem position sensor in accordance with the present disclosure, and is not intended to represent the only forms in which the present disclosure may be implemented or utilized. The description sets forth the features of the present disclosure in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like elements or features.

Aspects of embodiments of the present disclosure are directed to a vehicle communication system utilizing the power line carrier (PLC) protocol to identify one of the electrically coupled tow vehicle and towed vehicle to the other. In some embodiments, the vehicle communication system includes a communication circuit that transmits a unique identifier that may be associated with the vehicle identification number (VIN)) of the tow/towed vehicle to a towed/tow vehicle whenever the power of the trailer is turned on. In some examples, the communication circuit broadcasts the unique identifier onto the vehicle's power line every time it detects a power cycle. When receiving electrical power, the communication circuit may also retransmit the unique identifier at regular intervals. The transmitted identifier, which may be detected by a receiver (e.g., a PLC gateway) at the receiving vehicle, may be used to determine the hook and unhook times of the trailer or tow vehicle, and may provide a positive confirmation that the tow vehicle is hooked up to the correct towed vehicle in real-time. This identification process may be done automatically without any input from the driver.

As used herein, a “towed vehicle” broadly refers to a trailer, a chassis, or any other vehicle that is towed by another vehicle. Further, a “tow vehicle” broadly refers to a tractor, truck, or any other vehicle that is capable of towing the towed vehicle.

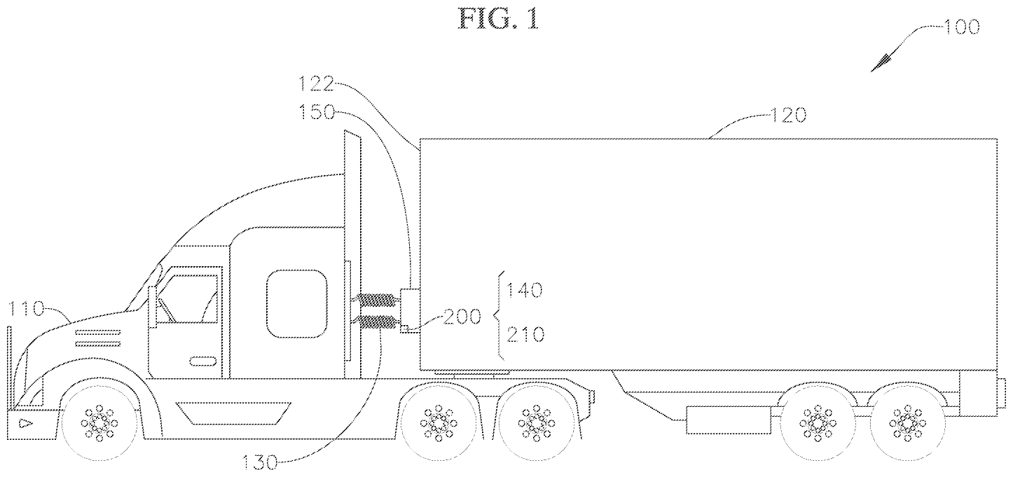

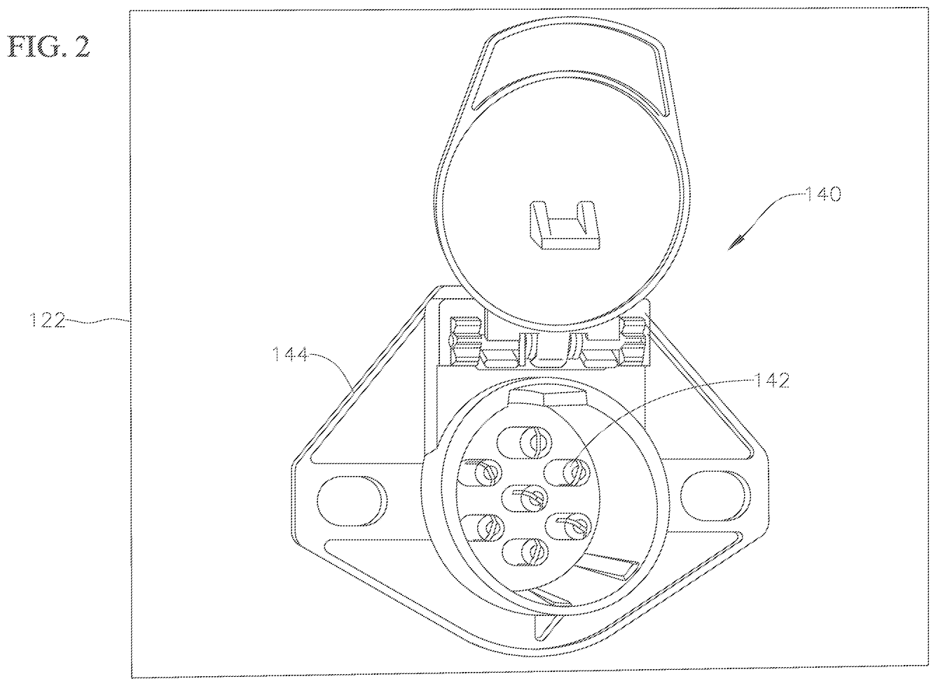

FIG. 1 illustrates a vehicle utilizing the vehicle communication system, according to some embodiments of the present disclosure. FIG. 2 illustrates a perspective view of an electrical connector of the vehicle communication system, according to some embodiments of the present disclosure.

As illustrated in FIG. 1, the heavy-duty vehicle 100 includes a or tow vehicle (e.g., a tractor or truck) 110 coupled to (e.g., hooked up to) a towed vehicle 120. The electrical systems of the tow vehicle 110 and towed vehicle 120 are connected to each other via an electrical cable/harness 130, which has a plurality of wires that can carry electrical power and various other signals between the two. In some embodiments, the vehicle communication system 200 includes an electrical connector (e.g., an electrical socket or plug; also referred to herein as an integrated electrical connector) 140 that is configured to receive electrical power from the tow vehicle 110 for supplying to the towed vehicle 120. The cable 130 and electrical connector 140 provide a means for the tow vehicle 110 to power, monitor, and control the electrical system of the towed vehicle 120.

In some examples, the electrical connector 140 may be an integrated electrical socket mounted to the back of tow vehicle 110 or the front of the towed vehicle 120 and is configured to mate with a corresponding plug end of the cable 130. In other examples, the electrical connector 140 may be an integrated electrical plug at one end of a cable 130 that is attached to the back of the tow vehicle 110 and is configured to mate with a corresponding socket at the front end of the towed vehicle 120.

As shown in FIG. 1, the electrical connector 140 may be located at (e.g., mounted to) the nose box 150; however, embodiments of the present disclosure are not limited thereto, and the electrical connector 140 may be mounted to a mounting surface 122 of the towed vehicle 120 at any suitable location, or may be mounted to the back of the tow vehicle 110. The electrical connector 140 of the vehicle communication system 200 may be mounted/installed by the original equipment manufacturer (OEM) of the corresponding vehicle, or may be installed as an aftermarket modification.

Referring to FIG. 2, the electrical connector 140 (which is shown as an electrical socket/receptacle) includes a plurality of pins 142 extending therethrough and away from the mounting surface 122, which electrically connect to corresponding wires of the cable 130 when the plug of the cable 130 is mated with the connector 140. As shown in FIG. 2, the electrical connector 140 may be a 7-way (i.e., 7-pin) SAE J560 (the society of automotive engineers for standard J560) connector; however, embodiments of the present disclosure are not limited thereto. A number of standards dictate the number of pins extending through the electrical connector 140. For example, in North America, 4-way, 5-way, 6-way, and 7-way connectors are standardized. Heavy-duty vehicles may use a connector that complies with SAE 1560, an example of which is shown in FIG. 2.

According to some embodiments, the vehicle communication system 200 further includes a communication circuit 210 integrated with, and within the housing 144 of, the electrical connector 140.

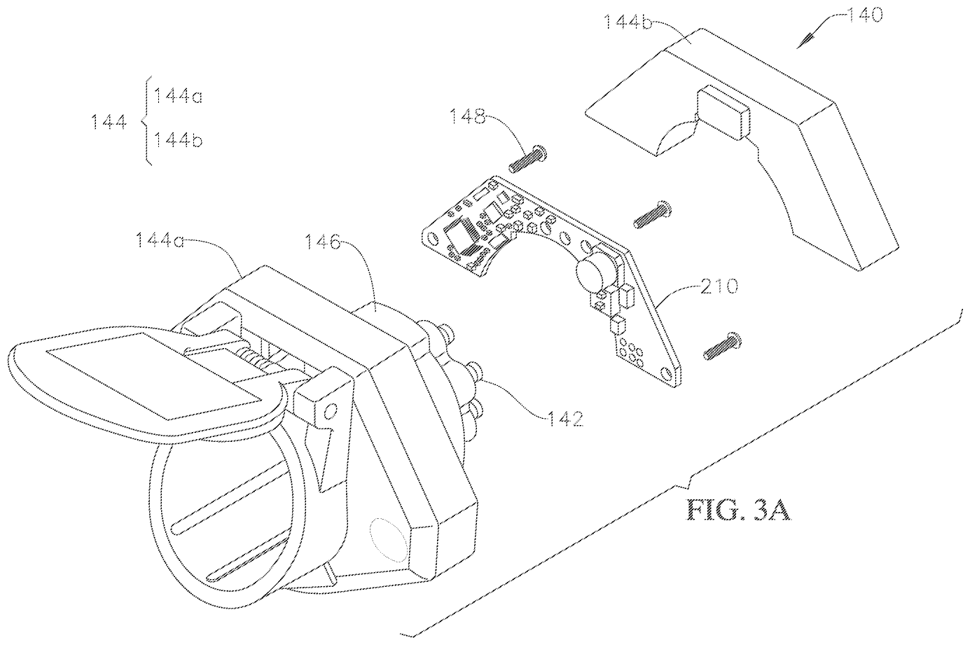

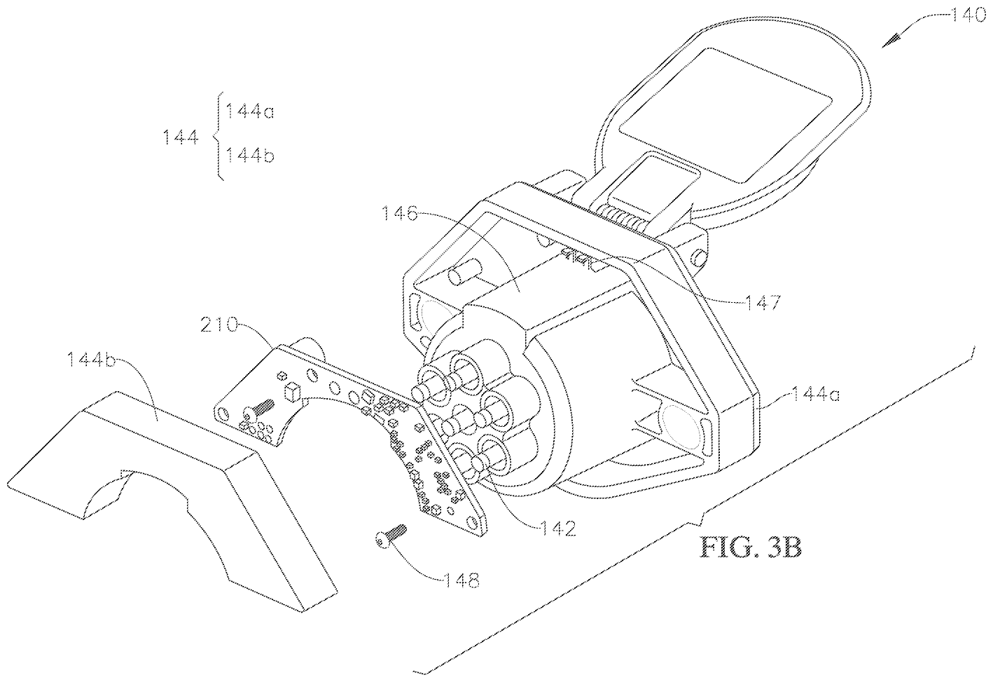

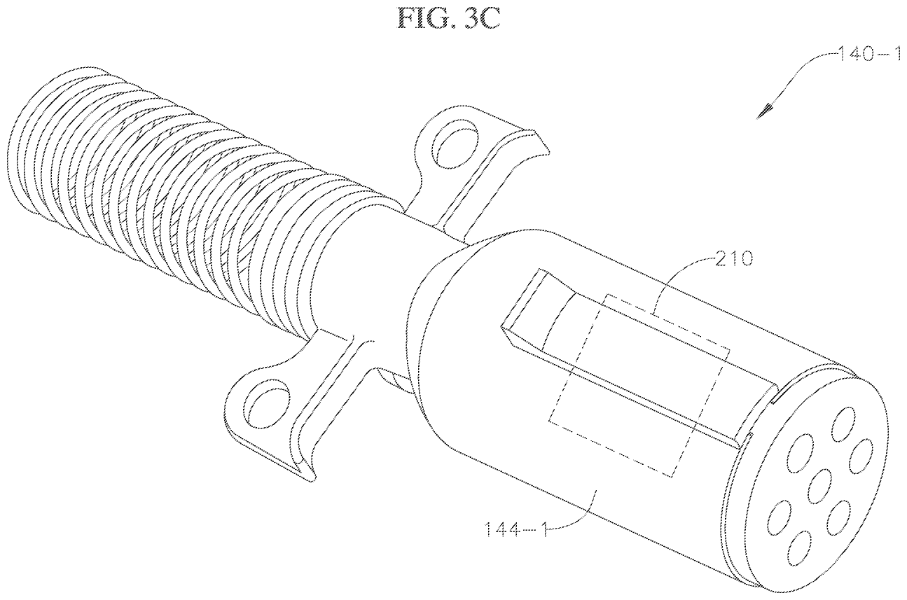

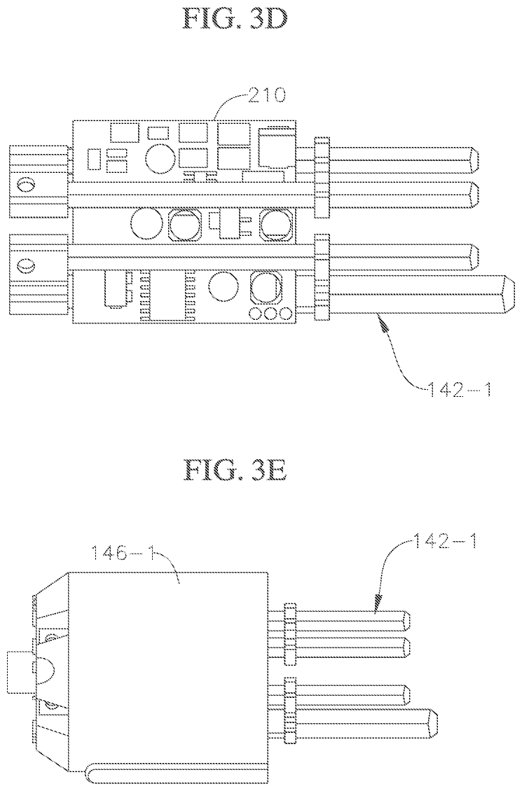

FIG. 3A illustrates a front exploded view of the electrical connector of the vehicle communication system, embodied as a socket, showing the communication circuit 200 in relation to the connector pins 142, according to some embodiments of the present disclosure. FIG. 3B illustrates a rear exploded view of the electrical connector 140 of FIG. 3A, according to some embodiments of the present disclosure.

Referring to FIGS. 3A and 3B, in some embodiments, the communication circuit 210 is sufficiently compact to fit within the housing 144 of the electrical connector 140. The communication circuit 210 may include electronic components mounted on a printed circuit board (PCB) that is shaped to wrap around an exterior of the chamber 146 and to fit between a front portion 144a and a rear portion (e.g., back plate) 144b of the housing. The chamber 146 may encapsulate a portion of each of the pins 142, while leaving an end portion of the pins 142 exposed to the outside so that they can make electrical contact with the corresponding contact terminals of a mating connector. The communication circuit 210 may be secured (fastened) to at least one of the front and rear portions 144a and 144b of the housing 144 via one or more screws 148 or any other suitable securing mechanism. In addition to securing the communication circuit 210 in place, the housing 144 may serve to protect the communication circuit 210 from the elements (such as dust, debris, moisture, etc.).

According to some embodiments, the communication circuit 210 is electrically connected to two or more of the pins 142 via one or more wire connections 147 that have one end attached and electrically connected to the two or more of the pins 142 on one and have another end that extends to the outside of the chamber 146 and are attached and electrically connected to the communication circuit 210. Thus, the wire connections 147 allow the circuitry of the communication circuit 210 to form electrical connections to each of the two or more pins 142, and from there to the corresponding wires of the harness 130.

In some embodiments, the communication circuit 210 is connected to at least a first pin that is configured to receive electrical power from the tow vehicle 110 and a second pin that is configured to act as a signal ground (or ground reference). The connection to the first and second pins allows the communication circuit 210 to transmit an identification signal on the first pin to a tow/towed vehicle 110/120, to identify the towed/tow vehicle 120/110 to which the vehicle communication system is attached or mounted. To enable signal transmission on a power line, the communication circuit 210 may transmit the identification signal at the power pin via a power line communication (PLC) protocol. The communication circuit 210 is configured to monitor the first pin (e.g., the voltage at the first pin) to detect the application of electrical power to the pin, and to transmit the identification signal at the first pin in response. Thus, the communication circuit 210 broadcasts the identification signal at every trailer/chassis power cycle or power reset.

In examples in which the electrical connector 140 is installed at the tow vehicle 110 (e.g., as an electrical socket mounted to the back of the tow vehicle 110 or as an electrical plug connected to the back of the tow vehicle 110), the communication circuit 210 begins broadcasting the identification signal to the towed vehicle 120 when the tow vehicle 110 is turned on. In examples in which the electrical connector 140 is installed at the towed vehicle 120 (e.g., as an electrical socket mounted to the front of the towed vehicle 120), the communication circuit 210 begins broadcasting the identification signal to the tow vehicle 110 when the tow and towed vehicles 110 and 120 are coupled together (e.g., hooked up) and the communication circuit 210 received power through the first pin (e.g., the power pin).

According to some embodiments, the communication circuit 210 is further connected to a third pin that is configured to receive a brake light power signal from the tow vehicle 110. The communication circuit 210 may monitor the third pin to detect the presence of the brake light power signal at the third pin, and may broadcast the identification signal in response to such detection at the third pin.

In some examples, in the presence of electrical power at the first pin (e.g., when the trailer/chassis 120 is receiving power), the communication circuit 210 may broadcast the identification signal at predetermined/preset intervals (e.g., regular and/or irregular intervals). For example, the communication circuit 210 may transmit every several seconds when first powered then transition to a less frequent interval of every minute to five minutes for subsequent broadcasts. This allows the tow vehicle 110 to determine when the trailer/chassis 120 has been disconnected (e.g., unhooked) from it.

In the embodiments of FIGS. 2, 3A, and 3B, the electrical connector has been shown and described as an integrated electrical socket; however, embodiments of the present disclosure are not limited thereto, and the electrical connector 140 may also be embodied as an integrated electrical plug, As shown in FIGS. 3C-3E.

FIG. 3C illustrates a perspective view of the connector of the vehicle communication system, embodied as a plug, according to some embodiments of the present disclosure. FIG. 3D illustrates a partial internal view of the electrical plug connector, showing the communication circuit in relation to the plug pins, according to some embodiments of the present disclosure. FIG. 3E illustrates a side view of an internal chamber of the plug connector, according to some embodiments of the present disclosure.

Referring to FIGS. 3C-3E, the communication circuit 210 is sufficiently compact to fit between the pins 142-1 and within the chamber 146-1 of the electrical plug 140-1. The internal chamber 146-1, which is accommodated within a housing of the electrical plug 140-1, may encapsulate communication circuit 210 and a portion of each of the pins 142-1, while leaving an end portion of the pins 142 exposed to the outside so that they can make electrical contact with the corresponding contact terminals of a mating connector (e.g., pins of a mating socket). As such, the chamber 146-1 may protect the communication circuit 210 from the elements (such as dust, debris, moisture, etc.).

In the example of a 7-way J560 connector (e.g., a J560 socket or plug), the first pin (e.g., the trailer power pin) may be pin 7 (e.g., corresponding to the blue wire), the second pin (e.g., the ground pin) may be pin 1 (e.g., corresponding to the white wire), and the third pin (e.g., the brake light pin) may be pin 4 (e.g., corresponding to the red wire). The first and third pins may be able to handle up to about 30 A of current.

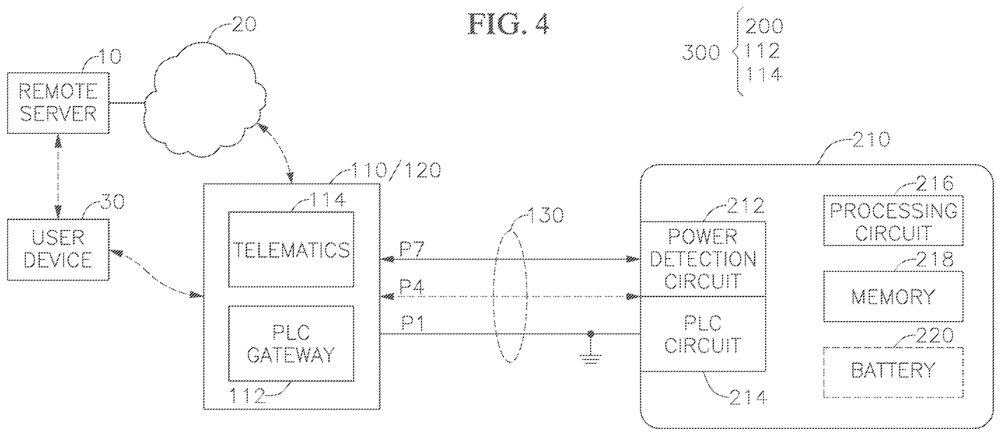

FIG. 4 illustrates a block diagram of the vehicle communication system 200 and its interconnection with the electrical system of the tow vehicle 110, according to some embodiments of the present disclosure.

According to some embodiments, the communication circuit 210 includes a power detection circuit 212 for monitoring the presence of power at the first pin (e.g., the power pin) and, in some embodiment, at the third pin (e.g., brake light pin); a PLC circuit 214 for transmitting the identification signal over the harness 130 via the PLC protocol; a processor (e.g., processing circuit) 216 for generating the identification and for determining when to broadcast the signal to the tow/towed vehicle 110/120; and a memory (e.g., non-volatile memory) 218 for storing the instructions that cause the processor to perform its functions. The memory 218 may also store the unique identifier, which may be the VIN of the towed/tow vehicle 120/110 at which the vehicle communication system 200 is installed, or may be a unique value identifying the vehicle communication system 200 that can be mapped to the VIN of the towed/tow vehicle 120/110. This identifier may be programmed into the memory 218 at the time of manufacture or at a later time by the end customer.

In some embodiments, the communication circuit 210 is configured to be electrically powered by at least one of the first and third pins. However, embodiments of the present disclosure are not limited thereto. For example, the communication circuit 210 may further include an internal battery (e.g., a rechargeable battery) 220 that is configured to power the communication circuit 210 in the absence of power on at least the first and third pins.

In some examples, the tow/towed vehicle 110/120, which is on the receiving end of the identification signal, includes a PLC receiver 112 for receiving and interpreting the identification signal transmitted by the communication circuit 210. The tow/towed vehicle 110/120 may also include a telematics gateway 114 for communicating the identifier of the trailer/chassis 120, as well as other information, to the driver and/or the dispatch/fleet manager.

In some examples, the telematics gateway 114 may use a cellular connection or a Wi-Fi connection to communicate with a remote server 10 (e.g., a remote server 10 on the cloud 20), which may compile and further process the received data. A user device 30 (see, e.g., FIG. 1) associated with the driver, which may be a display in the cab of the truck 110 or a mobile device (e.g., a tablet or a phone) of the driver, may receive information, such as the unique identifier of the trailer/chassis 120 from the remote server 10 via a cellular or Wi-Fi connection. However, embodiments of the present disclosure are not limited thereto, and the communication circuit 210 may communicate with the user device via the PLC gateway 112.

In some examples, the PLC gateway 112 and the telematics gateway 114 may be installed at the tow vehicle 110 or at the trailer/chassis 120 (e.g., at the nose box 150).

According to some embodiments, to improve security and to prevent or substantially reduce the likelihood of eavesdropping on the communication between the vehicle communication system 200 and the tow/towed vehicle 110/120 by an unauthorized user (e.g., outside attacker), the communication circuit 210 may encode the unique identifier of the trailer/chassis 120 prior to transmitting it via PLC to the tow/towed vehicle 110/120. For example, the transmitted identification signal may be based on a unique identifier and an encryption key, and include a code indicating whether the identifier is encrypted or not. The identifier may include the VIN of the vehicle 110/120 to which the vehicle communication system 200 is attached or a unique value identifying the vehicle communication system 200, which can be mapped to the VIN of the vehicle 110/120. In some examples, the encryption key may be based on a manufacturing date of the vehicle 110/120 to which the vehicle communication system 200 is attached; however, embodiments of the present disclosure are not limited thereto, and any suitable encryption key may be utilized. The code may be one or more binary bits (e.g., a ‘0’ or a ‘1’) that is set by the processor 216 depending on whether the identifier is coded or not.

According to some embodiments, the communication circuit 210 (e.g., the processor 216) codes the identifier of the trailer/chassis 120 by intertwining the bits of the identifier with a random value (e.g., random seed value), encoding the intertwined value, and scrambling the bits of the encrypted value to generate the identification signal to be transmitted to the receiving tow/towed vehicle 110/120. Here, the vehicle communication system 200 together with the PLC receiver and telematics circuit may form a vehicle identification system 300.

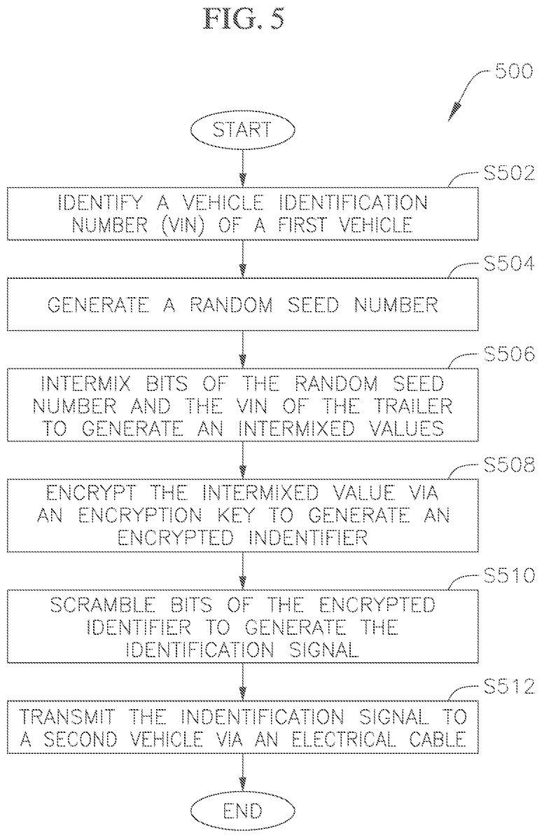

FIG. 5 is a flow diagram illustrating the process 500 of transmitting the identification signal by the vehicle communication system 200, according to some embodiments of the present disclosure.

In some embodiments, the communication circuit 210 of the vehicle communication system 200 identifies the unique identifier (e.g., VIN) of the trailer/chassis 120 (S502). The communication circuit 210 generates a random seed number (S504), and intertwines (e.g., intermixes) bits of the random seed number and the identifier to generate an intertwined value (e.g., an intermixed value; S506).

In some examples, the random seed number may be generated by passing a clock signal with sloping sides (i.e., a dirty/unclean clock signal) through an analog-to-digital converter (ADC), which produces a random number that may be used as a seed number to be used for encryption. However, this is merely an example, and any other suitable form of random seed generation may be utilized. This allows the communication circuit 210 to generate a unique seed number at each power up thus insuring a unique and different serial of random numbers to be used for each transmission.

The intertwining of the binary bits of the random seed number and the identifier may be performed by, for example, arranging the bits of the identifier into the even/odd bit positions of the intertwined value, and arranging the bits of the random seed number into the odd/even bit positions of the intertwined value. However, this is merely an example, and any other suitable form of bit intertwining may be utilized.

The communication circuit 210 then encrypts the intertwined value via an encryption key to generate an encrypted identifier (S508), and scrambles bits of the encrypted identifier to generate the identification signal (S510). Encryption may be implemented by performing an binary XOR operation on the intertwined value and the encryption key. However, this is merely an example, and any other suitable form of encryption may be utilized.

Finally, the communication circuit 210 transmits the identification signal to the receiving tow/towed vehicle 110/120 (e.g., via the electrical cable 130 coupling the tow vehicle 110 to the towed vehicle 120).

In some embodiments, the PLC receiver 112 at the receiving tow/towed vehicle 110/120 decodes the identification signal to obtain the unique identifier by performing the reverse of the operations described above. This allows the receiving tow/towed vehicle 110/120 to properly identify the transmitting towed/tow vehicle 120/120 when the unique identifier includes the VIN of the transmitting towed/tow vehicle 120/110. However, when the unique identifier is that of the vehicle communication system 200, the telematics circuit 114 may send this identifier to the remote server 10 to lookup the VIN number of the transmitting towed/tow vehicle 120/110 associated with the vehicle communication system 200. The telematics circuit 114 may then receive the VIN to enable the receiving tow/towed vehicle 110/120 to properly identify the transmitting towed/tow vehicle 120/120. However, embodiments of the present disclosure are not limited thereto, and in some examples, the decoding of the unique identifier may be performed at the remote server 10 rather than at the PLC receiver 112.

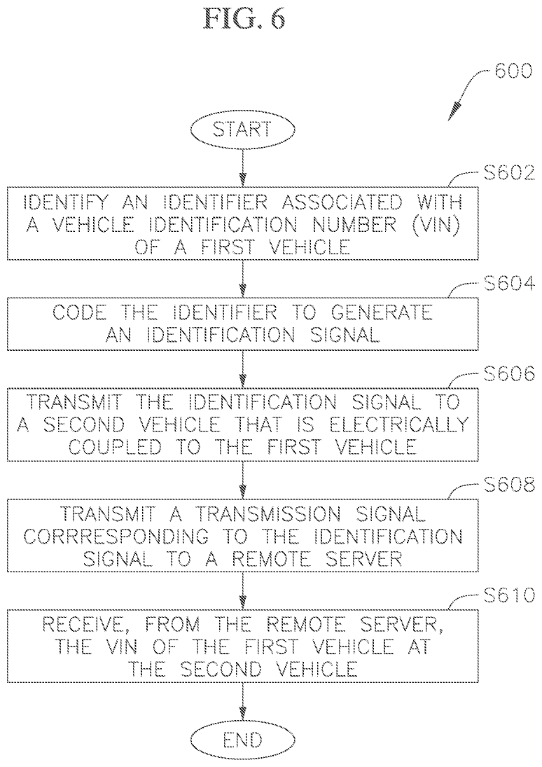

FIG. 6 is a flow diagram illustrating the process 600 of vehicle identification by the a vehicle identification system 300, according to some embodiments of the present disclosure.

In some embodiments, the vehicle communication system 200 (e.g., the communication circuit 210) identifies an identifier associated with a vehicle identification number (VIN) of a first vehicle 120/110 (S602), and codes the identifier to generate an identification signal (S604). The process of coding the unique identifier may be the same or substantially the same as that described above with respect to FIG. 5 (e.g., S504 to S510).

The vehicle communication system 200 then transmits the identification signal to a second vehicle 110/120 that is electrically coupled to the first vehicle 120/110 (S606). The PLC receiver 112 at the second vehicle 110/120 may receive the identification signal.

The telematics circuit 114 then transmits a transmission signal corresponding to the identification signal to the remote server 10 for processing (S608). In some examples, the transmission signal may be the decoded identification signal (i.e., the unique identifier) or may be or include the identification signal itself (which the remote server 10 may decode to obtain the unique identifier). The remote server 10 may determine the VIN of the first vehicle 120/110 that is associated with the unique identifier. It may do so using a look-up table that maps the unique identifier to the VIN of the first vehicle 120/110.

The telematics circuit 114 at the second vehicle 110/120 may then receive, from the remote server 10, the VIN of the first vehicle 120/110 (S610).

Accordingly, as described above, the vehicle communication system provides a trailer/chassis connector (e.g., electrical connector) with an integrated identifier broadcast capability. This eliminates the need to purchase and install a separate PLC tag at the fuse box. Further, all the electronics and connections needed are included in the connector, and no additional installation beyond that already needed for a trailer/chassis connector is involved. Thus, the vehicle communication system described herein provides a lower cost solution for positive tractor and trailer/chassis identification because the cost may be minimally higher than that a trailer connector without the ID feature. The unique identifier of the trailer/chassis may be programmed into the communication circuit either at the factory or at the site of the end customer.

As used herein, the term “processor” or “processing circuit” includes any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The various components of the vehicle identification system, such as the communication circuit, the PLC receiver, and the telematics circuit and/or any other relevant devices or components according to embodiments of the present invention described herein may be implemented utilizing any suitable hardware, firmware (e.g., an application-specific integrated circuit), software, or a suitable combination of software, firmware, and hardware. For example, the various components of the vehicle identification system may be formed on one integrated circuit (IC) chip or on separate IC chips. Further, the various components of the vehicle identification system may be implemented on a flexible printed circuit film, a tape carrier package (TCP), a printed circuit board (PCB), or formed on a same substrate. Further, the various components of the vehicle identification system may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The present disclosure is not to be limited in scope by the specific embodiments described herein. Indeed, other various embodiments of and modifications to the present disclosure, in addition to those described herein, may be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art may recognize that its usefulness is not limited thereto and that the present disclosure may be beneficially implemented in any number of environments for any number of purposes. Accordingly, the claims set forth below should be construed in view of the full breadth and spirit of the present disclosure as described herein and equivalents thereof.

Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A vehicle communication system comprising:
an electrical connector coupled to a first vehicle and comprising a plurality of pins configured to carry signals between the first vehicle and a second vehicle, the plurality of pins comprising a first pin configured to receive electrical power and a second pin configured to act as a signal ground; and
a communication circuit coupled to the first and second pins of the electrical connector and configured to transmit an identification signal on the first pin to the second vehicle.

2. The vehicle communication system of claim 1, wherein the communication circuit is within a housing of, and integrated within, the electrical connector.

3. The vehicle communication system of claim 1, wherein the identification signal is configured to identify the first vehicle to the second vehicle.

4. The vehicle communication system of claim 1, wherein the first vehicle is tow vehicle and the second vehicle is a towed vehicle.

5. The vehicle communication system of claim 1, wherein the first vehicle is towed vehicle and the second vehicle is a tow vehicle.

6. The vehicle communication system of claim 1, wherein the communication circuit is configured to transmit the identification signal via a power line communication (PLC) protocol.

7. The vehicle communication system of claim 1, wherein the plurality of pins further comprises a third pin configured to receive a brake light power signal from the second vehicle, and
wherein the communication circuit is further coupled to the third pin and is configured to monitor presence of the brake light power signal at the third pin.

8. The vehicle communication system of claim 7, wherein the communication circuit is further configured to transmit the identification signal in response to presence of the brake light power signal.

9. The vehicle communication system of claim 1, wherein the communication circuit is configured to be electrically powered through the first and second pins.

10. The vehicle communication system of claim 1, wherein the communication circuit comprises an internal battery configured to power the communication circuit in the absence of power on the first pin.

11. The vehicle communication system of claim 1, wherein the communication circuit is configured to detect application of power to the first pin and to transmit the identification signal in response to detecting the application of power.

12. The vehicle communication system of claim 1, wherein the electrical connector is a 7-pin J560 socket or a 7-pin J560 plug.

13. The vehicle communication system of claim 1, wherein the identification signal is based on an identifier associated with a vehicle identification number (VIN) of the first vehicle and an encryption key, and comprises a code indicating whether the identifier is encrypted.

14. The vehicle communication system of claim 13, wherein the identifier comprises the VIN of the first vehicle or a unique value identifying the vehicle communication system, the unique value being mapped to the VIN of the first vehicle.

15. The vehicle communication system of claim 13, wherein the encryption key is based on a manufacturing date of the first vehicle, and the code comprises a binary bit.

16. The vehicle communication system of claim 1, wherein the communication circuit is configured to generate the identification signal by encrypting an identifier associated with a vehicle identification number (VIN) of the first vehicle via an encryption key.

17. The vehicle communication system of claim 1, wherein the communication circuit is configured to generate the identification signal by:
generating a random seed number;
intertwining bits of the random seed number and an identifier associated with a vehicle identification number (VIN) of the first vehicle to generate an intertwined value;
encrypting the intertwined value via an encryption key to generate an encrypted identifier; and
scrambling bits of the encrypted identifier to generate the identification signal.

18. A method of transmitting an identification signal by a vehicle communication system, the method comprising:
identifying an identifier associated with a vehicle identification number (VIN) of a first vehicle coupled to the vehicle communication system;
generating a random seed number;
intertwining bits of the random seed number and the identifier to generate an intertwined value;
encrypting the intertwined value via an encryption key to generate an encrypted identifier;
scrambling bits of the encrypted identifier to generate the identification signal; and
transmitting the identification signal to a second vehicle coupled to the first vehicle.

19. The method of claim 18, wherein the identifier comprises the VIN of the first vehicle or a unique value identifying the vehicle communication system, the unique value being mapped to the VIN of the first vehicle.

20. A method of vehicle identification, the method comprising:
identifying an identifier associated with a vehicle identification number (VIN) of a first vehicle;
coding the identifier to generate an identification signal;
transmitting the identification signal to a second vehicle that is electrically coupled to the first vehicle;
transmitting a transmission signal corresponding to the identification signal to a remote server; and
receiving, from the remote server, the VIN of the first vehicle at the second vehicle.
